(19) United States
(12) Patent Application Publication
(10) Pub. No.: US 2007/0249779 A1
(43) Pub. Date: Oct. 25, 2007

(54) COMPOSITION FOR, AND METHOD OF, SEALING CRACKS IN CONCRETE

(76) Inventors: Mark Dellandrea, Rockwood (CA); Witek Majewski, Breslan (CA)

Correspondence Address: HOFFMANN & BARON, LLP, 6900 JERICHO TURNPIKE, SYOSSET, NY, 11791, US

(21) Appl. No.: 11/689,158

(22) Filed: Mar. 21, 2007

(30) Foreign Application Priority Data
Apr. 24, 2006 (CA) 2541975

(51) Int. Cl. C08F 120/10; C09B 67/00

(52) U.S. Cl. 524/502; 525/330.3

(57) ABSTRACT

A composition for and method of sealing cracks in concrete in the absence or presence of water is disclosed, where the composition includes at least one acrylate monomer having acrylate groups and at least one curing agent capable of cross-linking acrylate groups, the curing agent being capable of cross-linking the acrylate groups in the presence of water to form a cross-linked acrylate compound. The method for sealing a crack in concrete includes the steps of blending at least one acrylate monomer having acrylate groups with at least one curing agent adapted to cross-link the acrylate groups to form a mixtures providing covering means to cover the crack to be sealed and applying the mixture under the covering means within the crack before the mixture cures.

### FIELD OF THE INVENTION

The present invention is directed to compositions for the sealing of cracks. More specifically the invention is directed to a composition for sealing cracks in concrete and a method for sealing cracks in concrete using the composition.

### BACKGROUND OF THE INVENTION

Various techniques and systems are known in the art for sealing or filling cracks in concrete, such as cracks in concrete structures, basement walls, foundations below and above grade. A typical technology for sealing concrete cracks on vertical surfaces involves crack injection. In this method, an applicator drills holes in the concrete structure proximate the crack, although preferably not in the crack itself. Then, using a high pressure pump, an injection resin, typically epoxy resin, is pumped under high pressure into the concrete surrounding the crack. If done correctly the resin seeps or finds its way into the crack from the inside of the concrete structure and gradually fills the crack. Various references on different aspects of resinous materials used for such high pressure injection are known in the art.

Another prior art technique for filling cracks in concrete includes the attachment of small plastic ports to a concrete surface directly on the face of a crack, after which the crack is thoroughly sealed with a two component epoxy resin or other type of mortar and a thermosetting material (epoxy) is inserted or pushed into the crack using a caulking gun or other similar device. As such, the two component resin is forced or “pushed” under pressure into the cracks. Various other techniques, with variations of the above techniques, exist, such as using a penetrating sealer or sealers which fill hairline cracks due to capillary action,

In contrast to the above, the present invention uses a novel sealer composition in which the combination of chemical properties, low viscosity and low surface tension allows the material to flow easily into the crack. This quasi “injection” is a low pressure process which does not require any special sealing of the face of the crack to be sealed, but rather uses an adhesive tape or other covering means for taping over or covering the crack. Another unexpected development resulting from the novel sealer composition of the present invention is the accelerated curing of the resinous material in the presence of water. This cure acceleration effect due to the presence of water allows for sealing wet, and actively leaking cracks.

At present, the use of concrete crack sealers utilizing acrylate monomers for accelerated cure in the presence of water is not known. Further, the use of adhesive tapes or other covering means to close the face of the crack and ensure the sealer penetrates inside is also not known in the art.

### SUMMARY OF THE INVENTION

In accordance with one aspect of the present invention there is provided a composition for sealing a crack in concrete, the composition comprising: at least one acrylate monomer having acrylate groups; and at least one curing agent capable of cross-linking the acrylate groups; the curing agent being capable of cross-linking the acrylate groups in the presence of water to form a cross-linked acrylate compound.

In accordance with another aspect of the present invention there is provided a method of sealing a crack in concrete comprising the steps of: blending at least one acrylate monomer having acrylate groups with at least one curing agent adapted to cross-link the acrylate groups to form a mixture; providing covering means to cover the crack to be sealed; and applying the mixture under the covering means within the crack before the mixture cures.

In accordance with a further aspect of the present invention, there is provided a composition for sealing cracks in concrete in the presence of water, the composition comprising at least one acrylate monomer having acrylate groups, and at least one curing agent capable of cross-linking acrylate groups, the curing agent being capable of cross-linking the acrylate groups in the presence of water to form a cross-linked acrylate compound.

In accordance with yet another preferred aspect of the present invention, there is provided a method of sealing a crack in concrete in the presence of water comprising the steps of blending at least one acrylate monomer having acrylate groups with at least one curing agent adapted to cross-link the acrylate groups to form a mixture, providing covering means to cover the crack to be sealed, and applying the mixture under the covering means within the crack before the mixture cures.

In accordance with yet a further aspect of the present invention there is provided a product for sealing cracks in concrete.

In accordance with yet another aspect of the present invention there is provided a method of sealing a crack in a horizontal concrete surface comprising the steps of: blending at least one acrylate monomer having acrylate groups with at least one curing agent adapted to cross-link the acrylate groups to form a mixture; and applying the mixture within the crack before the mixture cures.

In accordance with yet a further aspect of the present invention there is provided a method of sealing a crack in a horizontal concrete surface in the presence of water comprising the steps of: blending at least one acrylate monomer having acrylate groups with at least one curing agent adapted to cross-link the acrylate groups to form a mixture; and applying the mixture within the crack before the mixture cures.

### DETAILED DESCRIPTION OF THE PREFERRED EMBODIMENTS

As noted hereinabove, the present invention relates to a novel composition for sealing cracks in concrete on vertical, horizontal and other cracked concrete surfaces, and a method for sealing cracks in concrete using the composition. The novel crack sealer in the preferred embodiment includes an acrylate monomer and an epoxy resin. This reactive blend is solidified (cured, hardened) by usage of amidoamine hardeners.

As will be understood by those skilled in the art to which the present invention pertains, the novel crack sealer or composition described herein and in the appended claims is adapted to fill and seal cracks in concrete in vertical, horizontal and other concrete surfaces, which are adapted to prevent water or other foreign matter from entering into the cracks. One advantageous aspect of the present invention is that the cross-linking reaction of the acrylate groups of the acrylate monomer is accelerated in the presence of water, a very beneficial effect in applications to concrete cracks actively seeping water. Furthermore, the accelerated cure in the presence of water prevents the composition from “wash out” from the cracks which are actively leaking water.

Desirably the sealer composition may further contain additional fillers, pigments, adhesion promoters and/or rheology modifiers. Suitable adhesion promoters may include functional silanes. The composition exhibits very good penetrating properties into concrete cracks.

In a preferred embodiment, and with respect to vertical, horizontal and other surfaces, the sealer composition is preferably injected underneath a transparent adhesive tape applied over the surface of the crack to be filled. For example, an adhesive tape is used together with a low pressure injection of the composition underneath the tape, without any attempts to pressure-push the material into the crack. Use of a transparent tape allows the user to see visually the injection of the composition and allows for visual control of the injection process.

As disclosed hereinbelow, there is provided a composition which is adapted to seal cracks in concrete, in which the curing time is accelerated in the presence of a water. In accordance with a preferred aspect of the present invention, the concrete crack sealer composition can be characterized as having two parts—part A which is the base, and part B which is the curative. Typically, part A of the composition includes one or more acrylate monomers such as manufactured by Sartomer. In accordance with a preferred aspect, in a product formulation it is possible to use difunctional acrylate monomers, trifunctional acrylate monomers, generally multifunctional acrylate monomers or various blends thereof. Part A of the composition may also include mono-functional acrylate monomers blended with multi-functional acrylates. As noted above, with respect to the monomers which comprise the base of part A, it is preferable that low viscosity, especially low surface tension, and water soluble or water reducible, monomers be used.

For example, suitable monomers for use in part A may include polyethylene glycol derivatives such as Methoxy Polyethylene Glycol Monoacrylate, Polyethylene Glycol (200) Diacrylate, Polyethylene Glycol (400) Diacrylate, Polyethylene Glycol (600) Diacrylate, Trimethylolpropane Triacrylate, Ethoxylated Trimethylolpropane Triacrylates with different ethoxylation levels.

Part A may also include a second resinous component which may be an epoxy resin, selected from commercially available liquid epoxy, modified epoxy or epoxy acrylate resins such as manufactured by Hexion or Dow Chemical. For example an epoxy acrylate resin, Epon Resin 8021 from Hexion, is used in one of the Examples hereinbelow. While typical liquid epoxy resins have only epoxy functional groups, there are modified epoxy resins which also have acrylate functional groups. The ratio of the epoxy functional groups to acrylate functional groups in part A can be within the range of 0:1 to about 9:1.

Part A of the composition may be modified by means typically used in paints and other sealants such as those used in the manufacturing industries, namely by the addition of fillers such as clay, calcium carbonates, talc etc., rheology modifiers such as bentonite clays and their modifications, fumed silica, and other similar modifiers. Other modifiers may include pigments, adhesion promoters, defoamers and other similar liquid property modifiers. A suitable adhesion promoter may be functional silanes, such as manufactured by Dow Chemical.

Part B of the composition includes a curative, typically used for cross-linking acrylate groups according to the Michael reaction and also suitable for cross-linking epoxide groups. Additionally, part B may contain one of the commercially available curatives or a blend of several commercially available curatives. For example, typical compounds from the chemical groups of aliphatic amines, cycloaliphatic amines, amidoamines or polyamides can be used as curatives in the present invention. It has been found that while using curatives from the amidoamines group of chemicals, the chemical reaction responsible for resin(s) and monomers cross-linking (hardening) accelerates rapidly in the presence of water. Such an effect has not been described in the prior art in the field to which the present invention pertains and is not readily predictable from the common general knowledge in the state of the art.

As is well known in the art, concrete is used to make many types of structures, including residential, commercial and manufacturing related structures and foundations. These structures commonly develop cracks upon exposure to both the environment and to man-made activities. As such, there are numerous compositions for sealing and/or filling cracked concrete which are well known in the art. Typically these compositions suffer from the disadvantages of being slow curing and unsuitable for use under wet conditions, or even for that matter, under water.

It has been found that the effect of rapid or accelerated curing in the presence of water has very important implications in the art to which the present invention pertains. For example, in a typical formulation, which involves two component resinous compositions for applications such as adhesives, sealants, sealers, patching mortars, etc., the final product is a result of a compromise to balance two contradictory requirements.

There are two primary requirements for a suitable crack sealing composition, including the requirement that the composition must have (1) a suitable “pot life” and (2) a suitable curing time.

With respect to the “pot life” after blending together part A and part B of the product, the chemical reaction has to be delayed for a suitable time to allow the product to be suitably introduced into a cracked concrete surface. Typically, this depends on the type of crack sealing product used and the desired use of such a product.

With respect to the curing time, after delivering the mixed product into the desired location or cracked concrete surface, the curing process should be as rapid as possible.

While some solutions have been proposed to overcome one or more disadvantages with regard to the pot life and curing time requirements, none of the known products overcome all of the disadvantages and meet the requirements as afforded by the composition of the present invention.

In the case of chemical products designed for repairs underwater or in the presence of water, the problem described above becomes extremely important. If the curing time is too long, there is a danger that the resinous material will be washed out by water and, in consequence, will not perform. Therefore most resinous, two component materials for underwater applications are designed to cure rapidly, therefore providing only a very short time for product placement.

A situation where two components can be mixed slowly and thoroughly in the absence of water, and then will cure rapidly when placed in a wet environment, is obviously very beneficial and contributes to the product performance.

A method of sealing a crack in a concrete surface in the presence of water is described herein below. In general terms, the composition to be applied to a crack is created by blending at least one acrylate monomer having acrylate groups with at least one curing agent adapted to cross-link the acrylate groups to form a mixture. Means for covering the crack to be sealed is provided, for example an adhesive tape or removable sealant, which is placed over the crack on the concrete surface. This covering is particularly beneficial on vertical concrete surfaces as the adhesive tape or sealant helps maintain the composition within the crack.

The blended composition is then applied to the crack under the adhesive tape before the mixture cures. As noted hereinabove, this may be done under low pressure injection through or underneath the tape.

The following Examples provide an illustration of the present invention. The Examples, however, should be not be construed as limiting the invention in any way. More specifically, the acceleration effect of the composition in the presence of water is demonstrated herein below, in use with commercially available amidoamine hardeners. More specifically, the following Examples demonstrate a preferred embodiment of the present invention.

Example 1 illustrates the cure acceleration in the presence of waters when part A consists of only acrylate monomers. Example 2 demonstrates the same effect when part A includes acrylate and epoxy components. Example 3 demonstrates the same acceleration effect with a different curative. Example 4 describes the composition and a method of its application

### EXAMPLE 1

A blend of two acrylate monomers (part A).
25 g of Polyethylene Glycol (400) Diacrylate (EM226)
10 g of Trimethytolpropane Triacrylate (EM231)
   was mixed with

Part B
13 g Epikure 3072 (amidoamine curative from Hexion)

The pot life of the mixture was 15 minutes (20° C.). Thin layer cure was approximately 4 hours

The same blend cured instantly (in seconds) after adding 10 g of water while mixing parts A and B.

### EXAMPLE 2

Part A
25 g of Polyethylene Glycol (400) Diacrylate (EM226) 15 g of Epi Rez 8021
   was mixed with:

Part B:
13 g Epikure 3072

The potlife of the mixture was 20 minutes.

The same blend cured instantly (in seconds) after adding water while mixing parts A and B.

### EXAMPLE 3

Part A:
25 g of Polyethylene Glycol (400) Diacrylate (EM226)
   was mixed with:

Part B:
6.6 g of Ancamide 2582 (amidoamine curative from Air Products)

The potlife of the mixtures was 98 minutes.

The potlife of the same mixture, with water added, was 8 minutes.

### EXAMPLE 4

A crack sealer composition was prepared as follows:

In a high shear mixer a blend of 80 g EpiRez 8021 and 20 g of Polyethylene Glycol (400) Diacrylate (EM226) was prepared. Into this blend 10 g of rheological additive Bentone SD2 and 30 g calcined clay were added and dispersed with high shear mixing. The resulting blend exhibited thixotropic properties: a layer up to 1 mm thick did not sag on a vertical surface.

The blend described above was mixed with 40 g Epikure 3072. Mixing of the two components was easily accomplished by placing both in a plastic container and shaking the container by hand. The resulting sealant exhibited a pot life of 20 minutes, with a thin layer cure of approximately four hours.

A simulation of a concrete crack was prepared by clamping a piece of glass to a 4×8 inch concrete sample. A gap of 0.7 mm was left between the glass and concrete. The simulated crack was taped with a transparent adhesive tape (3M transparent mounting tape). Then a sealer prepared as described above was injected underneath the tape using a syringe and needle. Material easily filled the simulated crack, without any tendency to lift the protective tape, and penetrated the crack to a depth of 1.5-2 inches. Subsequently the material solidified (hardened) thus completely and permanently sealing the crack.

In an alternative embodiment, the composition of the present invention may be used without water being present in the cracks. Water may be added to the composition to accelerate the curing time.

With respect to applications on generally horizontal or near horizontal surfaces, the use of an adhesive tape or removable sealant may not be necessary. In an environment where water is present, a user may use a covering means or adhesive sealant to ensure that the composition cures within the cracked surface.

Although preferred embodiments of the present invention have been described hereinabove, it will be appreciated that various modifications of the present invention may be possible in light of the above teachings and within the purview of the appended claims without departing from the spirit and scope of the present invention.

What is claimed is:

1. A composition for sealing a crack in concrete, the composition comprising
at least one acrylate monomer having acrylate groups; and
at least one curing agent capable of cross-linking the acrylate groups, the at least one curing agent being capable of cross-linking the acrylate groups in the presence of water to form a cross-linked acrylate compound.

2. The composition according to claim 1, wherein the composition further includes at least one epoxy resin.

3. The composition according to claim 2, wherein the ratio of epoxy functional groups to acrylate functional groups is between 0:1 and about 9:1.

4. The composition according to claim 1, wherein the at least one acrylate monomer comprises monofunctional acrylate monomers blended with multifunctional acrylates, difunctional acrylate monomers, trifunctional acrylate monomers, difunctional acrylate monomers blended with trifunctional acrylate monomers, polyethylene glycol diacrylate blended with trimethylolpropane triacrylate or polyethylene glycol acrylate.

5. The composition according to claim 1, wherein the at least one curing agent comprises aliphatic amines, cycloaliphatic amines, amidoamines or polyamides.

6. The composition according to claim 1, wherein the composition further comprises at least one component selected from the group consisting of: a filler, a rheology modifier, a pigment, an adhesion promoter and a defoamer.

7. The composition according to claim 2, wherein the at least one epoxy resin comprises liquid epoxy resins, modified epoxy resins or epoxy acrylate resins.

8. A method of sealing a crack in concrete comprising the steps of:
blending at least one acrylate monomer having acrylate groups with at least one curing agent adapted to cross-link the acrylate groups to form a mixture;
providing covering means to cover the crack to be sealed; and
applying the mixture under the covering means within the crack before the mixture cures.

9. The method according to claim 8, wherein the composition further includes at least one epoxy resin.

10. The method according to claim 8, wherein the at least one acrylate monomer comprises monofunctional acrylate monomers blended with multifunctional acrylates, difunctional acrylate monomers, trifunctional acrylate monomers, difunctional acrylate monomers blended with trifunctional acrylate monomers, polyethylene glycol diacrylate blended with trimethylolpropane triacrylate or polyethylene glycol acrylate.

11. The method according to claim 8, wherein the at least one curing agent comprises aliphatic amines, cycloaliphatic amines, amidoamines or polyamides.

12. The method according to claim 8, wherein the covering means is an adhesive tape.

13. The method according to claim 8, wherein the step of applying the mixture to the crack further comprises introducing the mixture through the covering means and into the crack.

14. The method according to claim 8, wherein the step of applying the mixture to the crack further includes injecting the composition into the crack underneath the covering means.

15. The composition according to claim 1, wherein the curing is accelerated in the presence of water.

16. The method according to claim 8, wherein the curing is accelerated in the presence of water.

17. Use of the composition as claimed in claim 1 for sealing cracks in concrete in an underwater environment.

18. Use of the composition as claimed in claim 1 for sealing cracks in concrete where water is actively flowing in the crack.

19. A method of sealing a crack in a horizontal concrete surface comprising the steps of:
blending at least one acrylate monomer having acrylate groups with at least one curing agent adapted to cross-link the acrylate groups to form a mixture; and
applying the mixture within the crack before the mixture cures.

20. The method according to claim 19, wherein the curing is accelerated in the presence of water.
